(19) United States
(12) Patent Application Publication
(10) Pub. No.: US 2010/0139075 A1
(43) Pub. Date: Jun. 10, 2010

(54) PUNCHING METHOD PROVIDING EXTENSION EFFECT

(75) Inventor: Tung-Hung HUANG, Chang Hwa City (TW)

Correspondence Address: Muncy, Geissler, Olds & Lowe, PLLC, 4000 Legato Road, Suite 310, FAIRFAX, VA, 22033, US

(73) Assignee: CHARNG JIN ENTERPRISE CO., LTD.

(21) Appl. No.: 12/328,647

(22) Filed: Dec. 4, 2008

(51) Int. Cl. B23P 11/00

(52) U.S. Cl. 29/520

(57) ABSTRACT

A punching method providing extension effect aims to form an oil seal sleeve. Through a mold with a gap formed therein a punching material can be compressed and extended during forming. By reducing the moving speed of the mold the forming speed also is slower. As a result, the roundness improves and surface roughness is reduced after the oil seal sleeve is formed. Thus there is no need to do follow-on lathing and polishing, and the formed oil seal sleeve can meet users' requirements. The invention can increase production speed and reduce production cost and material loss.

### FIELD OF THE INVENTION

The present invention relates to a metal fabrication method and particularly to a fabrication method to produce oil seal sleeves at desired specifications by punching.

### BACKGROUND OF THE INVENTION

Referring to FIG. 1, an oil seal sleeve 10 is an important element of hydraulic equipment. It aims to keep lubrication oil from leaking. The roundness and surface roughness of the oil seal sleeve 10 have to meet a required specification. The conventional method of fabricating the oil seal sleeve 10 includes preparing an upper mold and a lower mold that mate each other up and down, disposing a sheet material between the upper mold and the lower mold, and punching the upper mold and the lower mold through a punching machine to form a semi-finished product of the oil seal sleeves.

While the semi-finished product of the oil seal sleeve thus made has a rough form of the finished product, its roundness and surface roughness still do not meet required standards. Hence follow-on lathing and polishing processes are still needed to get the desired roundness and surface roughness to meet the required standards. These processes are tedious, and take a lot of time and are costly. They also make mass production difficult.

### SUMMARY OF THE INVENTION

Therefore, the primary object of the present invention is to provide a punching method that does not require follow-on fabrication processes to make oil seal sleeves to meet required specifications.

The punching method according to the invention aims to form an oil seal sleeve. The method includes steps of: preparing a mold which has an upper mold and a lower mold couplable to form a desired gap therebetween, preparing a sheet material at a selected thickness greater than the gap of the mold, preparing a punching machine which has a movable upper chassis to hold the upper mold and a still lower chassis to hold the lower mold, disposing the sheet material between the upper mold and the lower mold, moving the movable upper chassis towards the still lower chassis to couple the upper mold and the lower mold and compress and extend the sheet material to form the oil seal sleeves.

The gap in the mold is smaller than the selected thickness of the sheet material. Hence during the forming process a compression and extension effect can be achieved. As a result, the dimension precision of the oil seal sleeve is higher and the surface roughness of the oil seal sleeve is smaller, thus the roundness and the surface roughness of the oil seal sleeve can meet required specifications.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a perspective view of an oil seal sleeve.

FIG. 2 is a sectional view of the mold of the invention.

FIG. 3 is a sectional view of the sheet material of the invention.

FIG. 4A is a schematic view of the invention in forming process-1.

FIG. 4B is a schematic view of the invention in forming process-2.

FIG. 4C is a schematic view of the invention in forming process-3.

### DETAILED DESCRIPTION OF THE PREFERRED EMBODIMENT

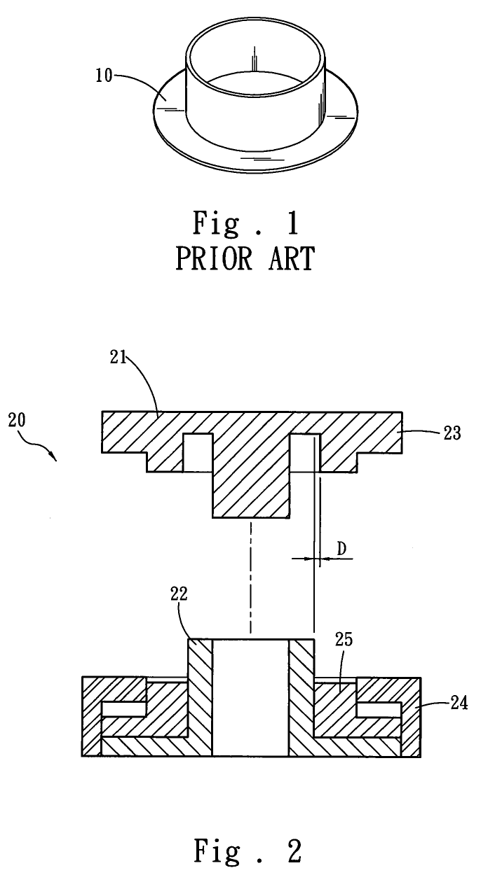

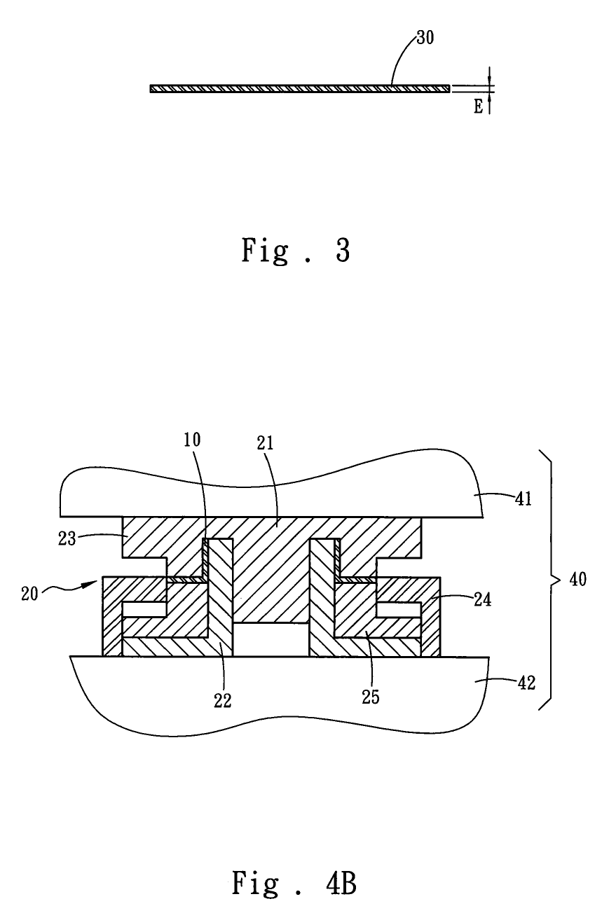

Please refer to FIG. 2, the invention provides a method to fabricate and form an oil seal sleeve 10 (referring to FIG. 1). The method includes steps of: first, preparing a mold 20 which includes an upper mold 21 and a lower mold 22 that are couplable to form a gap D between them.

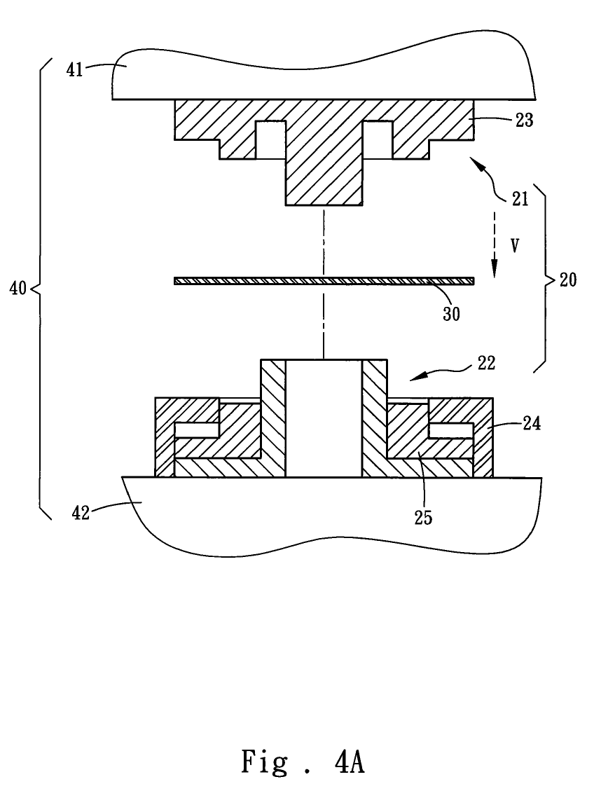

Referring to FIG. 3, then prepare a sheet material 30 at a selected thickness E greater than the gap D. For instance, for the selected thickness E of 1.2 mm, the gap D may be 0.65-0.9 times of E, namely D is between 0.78 mm and 1.08 mm. The sheet material 30 may be an SAE1008 steel sheet.

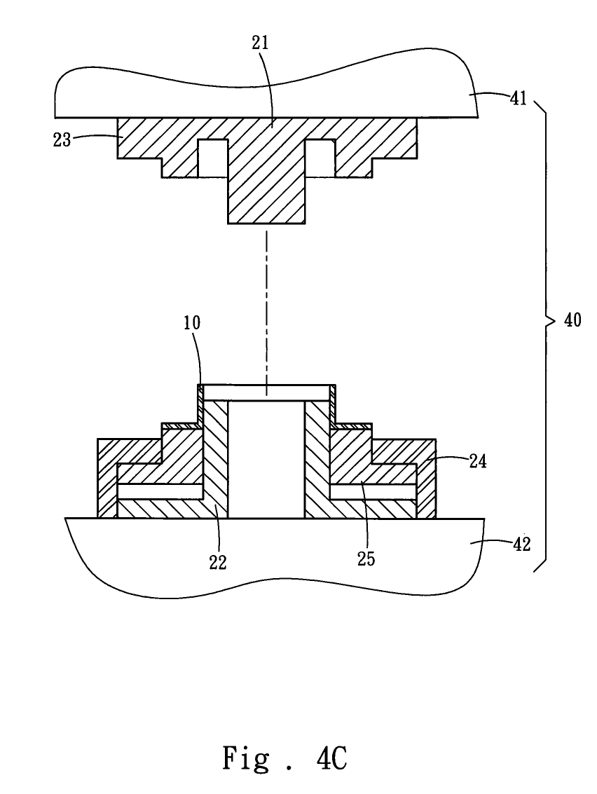

Referring to FIGS. 4A through 4C, prepare a punching machine 40 which has a movable upper chassis 41 and a still lower chassis 42 to hold respectively the upper mold 21 and the lower mold 22. Next, dispose the sheet material 30 between the upper mold 21 and the lower mold 22; then move the movable upper chassis 41 towards the still lower chassis 42 to compress and extend the sheet material 30 through the upper mold 21 and the lower mold 22 to form the oil seal sleeve 10.

As the gap D is smaller than the selected thickness E, during the forming process a compression and extension effect is generated. Hence the finished oil seal sleeve 10 is formed at a dimension more precise, and the roundness of the oil seal sleeve 10 is enhanced, and the surface roughness thereof is reduced.

The punching machine 40 can be driven by a motor (not shown in the drawings) to move the movable upper chassis 41. The rotation speed of the motor can be reduced to slow the moving speed V of the movable upper chassis 41 towards the still lower chassis 42 so that the forming speed is slower and material strain also is lower to further enhance the roundness and reduce the surface roughness of the finished oil seal sleeve 10. For instance, by reducing the rotation speed of the motor from 800-900 RPM to 600-700 RPM, the final surface roughness can reach 0.2-0.9 μm.

Moreover, the upper mold 21 may have an annular flange 23 extended from the perimeter to increase the thickness of the upper mold 21, then deformation of the upper mold 21 can be reduced during the forming process to further improve the roundness of the oil seal sleeve 10. The lower mold 22 may have an annular sever portion 24 on the lateral side to incorporate with the upper mold 21 to cut off the extra portion of the sheet material 30 on the periphery. Such a structure can facilitate automatic feeding of a strip type sheet material 30. Moreover, an annular mold release ring 25 may be provided between the sever portion 24 and the lower mold 22 to push the formed oil seal sleeve 10 upwards to be separated from the lower mold 22 after the forming process is finished and prevent the oil seal sleeve 10 from stuck to the lower mold 22.

As a conclusion, the method of the invention, by having a smaller gap in the mold 20, can provide a compression and extension effect during the forming process. In addition, by reducing the moving speed of the upper mold 21, the forming speed is slower. And by increasing the rigidity of the upper mold 21, the finished oil seal sleeve 10 has an enhanced roundness and desired surface roughness to meet the required specifications. Thus the follow-on lathing and polishing processes required in the conventional techniques are no longer needed in the invention. Moreover, mass production is possible and production cost is lower.

What is claimed is:

1. A punching method providing an extension effect to form an oil seal sleeve, comprising the steps of:
preparing a mold which has an upper mold and a lower mold that are couplable to form a gap therebetween;
preparing a sheet material at a selected thickness of 1.2 mm which is greater than the gap formed between 0.65 times and 0.9 times of the selected thickness;
preparing a punching machine which has a movable upper chassis and a still lower chassis to hold respectively the upper mold and the lower mold;
disposing the sheet material between the upper mold and the lower mold; and
moving the movable upper chassis towards the still lower chassis to compress and extend the sheet material to form the oil seal sleeve.

2. The punching method of claim 1, wherein the sheet material is an SAE1008 steel sheet.

3. The punching method of claim 1, wherein the punching machine is driven by a motor to move the movable upper chassis, the motor being controllable to reduce the rotation speed thereof to slow the downward moving speed of the movable upper chassis towards the still lower chassis.

4. The punching method of claim 3, wherein the rotation speed of the motor is reduced from 800-900 RPM to 600-700 RPM to form the oil seal sleeve with a surface roughness between 0.2 μm and 0.9 μm.

5. The punching method of claim 1, wherein the upper mold has an annular flange extended from the perimeter thereof.

6. The punching method of claim 1, wherein the lower mold has a sever portion located on a lateral side.

7. The punching method of claim 6, wherein the sever portion and the lower mold are interposed by an annular mold release ring.
